(19) United States
(12) Patent Application Publication
(10) Pub. No.: US 2002/0031188 A1
(43) Pub. Date: Mar. 14, 2002

(54) Data transmission system, data transmitting apparatus and method, and scene description processing unit and method

(76) Inventors: Shinji Negishi, Kanagawa (JP); Hideki Koyanagi, Kanagawa (JP); Yoichi Yagasaki, Tokyo (JP)

Correspondence Address: RADER, FISHMAN & GRAUER, P.L.L.C, 1233 20th Street, NW, Suite 501, Washington, DC, 20036, US

(21) Appl. No.: 09/931,577

(22) Filed: Aug. 17, 2001

(30) Foreign Application Priority Data
Aug. 21, 2000 (JP) P2000-250376

(51) Int. Cl. H04B 1/66; H04N 7/12; H04N 11/02; H04N 11/04

(52) U.S. Cl. 375/240.26; 709/247

(57) ABSTRACT

According to the present invention, a scene description that conforms to the state of a transmission line or the processing ability of a receiving side can be transmitted. Consequently, occurrence of a drawback such as unexpected missing of part of a scene that is unintended to a transmitting side is avoided. Even when a transmission rate is changed, signals are decoded according to a scene construction that conforms to the resultant transmission rate. A change in information needed to decode signals is explicitly reported to the receiving side. This relieves the receiving side of the necessity of sampling the information, which is needed to decode signals, from the signals. A data transmission system consists mainly of a server that transmits a scene description which describes the structure of multimedia data to be used to construct a scene, and a receiving terminal that constructs the scene according to the scene description. The server includes a scene description processing unit that transfers a scene description which conforms to the state of a transmission line and/or a request issued from the receiving terminal.

### BACKGROUND OF THE INVENTION

1. Field of the Invention

The present invention relates to a data transmission system, a data transmitting apparatus and method, and a scene description processing unit and method, wherein a scene description based on which a scene is constructed using multimedia data that includes a still image signal, a motion picture signal, an acoustic signal, text data, and graphic data is distributed over a network, received by receiving terminals, and decoded for display.

2. Description of the Related Art

FIG. 20 shows the configuration of a conventional data distribution system in which a motion picture signal, an acoustic signal, and others are transmitted over a transmission medium, received by receiving terminals, and decoded for display. Hereinafter, the motion picture signal, acoustic signal, and others that are encoded in compliance with the ISO/IEC 13818 (so called the MPEG2) shall be referred to as elementary streams (ESs).

Referring to FIG. 20, an ES processing unit 103 included in a server 100 selects any of ESs stored in advance in a memory 104 or receives a baseband image signal or acoustic signal that is not shown, and encodes the ES or signal. At this time, a plurality of ESs may be selected. A transmission control unit 105 included in the server 100 multiplexes a plurality of ESs if necessary, encodes a resultant signal according to a protocol according to which a signal is transmitted over a transmission medium 107, and transmits the signal to a receiving terminal 108.

A reception control unit 109 included in the receiving terminal 108 decodes the signal, which is transmitted over the transmission medium 107, according to the protocol. If necessary, the reception control unit 109 separates the multiplexed ESs, and hands the ESs to associated ES decoding units 112. The ES decoding unit 112 decodes an ES to restore a motion picture signal, an acoustic signal, or the like, and sends the signal to a display sounding unit 113 that includes a television monitor and a loudspeaker. Consequently, images are displayed on the television monitor and sounds are radiated through the loudspeaker.

The server 100 corresponds to a transmission system installed at a broadcasting station that provides a broadcasting service, or an Internet server or a home server that gives access to the Internet. Moreover, the receiving terminal 108 corresponds to a receiver for receiving a broadcast signal or a personal computer.

There is a drawback that when a change in a bandwidth offered by a transmission line (transmission medium 107) or a traffic-jammed state on the transmission line leads to a delay in data transmission or a loss in transmitted data.

In order to overcome the drawback, the data distribution system shown in FIG. 20 performs actions described below.

The server 100 (for example, the transmission control unit 105) assigns a (encoded) serial number to each packet in the form of which data is transmitted over a transmission line. The reception control unit 109 in the receiving terminal 108 monitors each packet received over the transmission line to see if an assigned (encoded) serial number is missing, and thus detects a loss in data (data loss rate). Otherwise, the server 100 (for example, the transmission control unit 105) appends (encoded) time instant information to data to be transmitted over the transmission line. The reception control unit 109 in the receiving terminal 108 monitors data received over the transmission line to see if (encoded) time instant information is appended to the data, and detects a delay in transmission from the time instant information. The reception control unit 109 in the receiving terminal 108 detects a data loss rate on the transmission line or a delay in transmission thereon, and transmits (reports) the detected information to a data-transmitted state detector 106 included in the server 100.

The data-transmitted state detector 106 in the server 100 receives the data loss rate on the transmission line or the delay in transmission thereon from the reception control unit 109 in the receiving terminal 108, and detects a bandwidth offered by the transmission line or a traffic-jammed state occurring thereon. If the data loss is large, the data-transmitted state detector 106 judges that the transmission line is jammed. Moreover, if a transmission line of a bandwidth reservation type is employed, the data-transmitted state detector 106 can detect an available bandwidth (bandwidth offered by the transmission line) usable by the server 100. When a transmission medium dominated by weather conditions, such as, radio waves is employed, a user may designate a bandwidth in advance according to the weather conditions. The information of a data-transmitted state detected by the data-transmitted state detector 106 is sent to a conversion control unit 101.

The conversion control unit 101 extends control according to the information of a detected bandwidth offered by a transmission line or a traffic-jammed state on the transmission line so that the ES processing unit 103 switches ESs that are transmitted at different bit rates. Otherwise, when the ES processing unit 103 encodes an ES in compliance with the ISO/IEC 13818 (so called the MPEG2), the conversion control unit 101 adjusts the encoding rate. Specifically, if it is detected that a transmission line is jammed, the ES processing unit 103 transfers an ES that is transmitted at a low bit rate. Consequently, a delay in data transmission can be avoided.

Moreover, for example, an unspecified large number of receiving terminals 108 may be connected to the server 100, and the specifications for the receiving terminals 108 may not be uniform. Therefore, the server 100 may have to transmit an ES to the receiving terminals whose processing abilities are different from one another. In the case of this system configuration, the receiving terminals 108 each include a transmission request processing unit 110. The transmission request processing unit 110 produces a transmission request signal to request an ES that conforms to the processing ability of the own receiving terminal 108. The transmission request signal is transmitted from the reception control unit 109 to the server 100. The transmission request signal includes a signal that expresses the ability of the own receiving terminal 108. The signal that is transmitted from the transmission request processing unit 110 to the server 100 and that expresses the ability of the own receiving terminal 108 is a signal representing, for example, a memory size, a resolution offered by a display unit, an arithmetic capability, a buffer size, an ES encoding format permitting decoding, a number of decodable ESs, or a bit rate at which a decodable ES is transmitted. In response to the transmission request signal, the conversion control unit 101 in the server 100 controls the ES processing unit 103 so that an ES that conforms to the performance of the receiving terminal 108 will be transmitted. Talking of image signal conversion for converting one ES into another that conforms to the performance of the receiving terminal 108, which is performed by the ES control unit 103, for example, an image signal converting method the present applicant has already proposed may be adopted.

Incidentally, as far as conventional telecasting is concerned, one scene is composed basically of an image (a still image alone or a motion picture alone) and sounds. Therefore, an image (a still image or motion picture) alone is displayed on the display screen of a conventional receiver (television receiver), and sounds alone are radiated from a loudspeaker.

In recent years, it has been thought that one scene is constructed using multimedia data that includes a still image signal, a motion picture signal, an acoustic signal, text data, graphic data, and other various signals. Methods of describing the construction of a scene based on the multimedia data include a method employing the hypertext markup language (HTML) that is adopted for home pages of web sites on the so-called Internet. Also included are a method employing the MPEG-4 binary format for the scene (BIFS) that is a scene description form stipulated in the ISO/IEC14496-1, a method employing the virtual reality modeling language (VRML) stipulated in the ISO/IEC14772, and a method employing Java (Trademark). Hereinafter, data describing the construction of a scene shall be referred to as a scene description. The scene description may include ES information that is needed to decode an ES to be used to construct a scene. Examples of the scene description will be described later.

The conventional data distribution system shown in FIG. 20 can construct and display a scene according to the scene description.

However, for example, as mentioned above, a bit rate at which an ES is transmitted may be controlled based on a change in a bandwidth offered by a transmission line or in a traffic-jammed state on the transmission line, or based on the performance of a receiving terminal. Even in this case, the conventional data distribution system decodes the ES according to a scene construction described in the same scene description and displays a scene using the resultant ES. In other words, the conventional data distribution system decodes the ES according to the same scene construction irrespective of whether the ES processing unit 103 modifies the ES, and displays a scene using the resultant ES. However, the scene construction cannot be said to be optimal for the modified ES. For example, if the bit rate for the ES is lowered, poor image quality may become distinctive. In contrast, although the bit rate for the ES is raised, an appropriate image may not be displayed.

Moreover, the conventional data distribution system shown in FIG. 20 can transmit a scene description together with ES information needed to decode an ES. As mentioned above, the conventional data distribution system constructs a scene according to the same scene description irrespective of whether the ES processing unit 103 modifies the ES. Therefore, for example, when the ES processing unit 103 changes the parameters for encoding the ES, ES information needed to decode the ES cannot be acquired from the data description. In this case, in the conventional data distribution system, the ES decoding unit 112 in the receiving terminal 108 has to sample the information, which is needed to decode the ES, from the ES itself. Consequently, the receiving terminal 108 has to incur a larger processing load, and it takes much time for sampling. This poses a problem in that decoding of an ES and display of an image using the ES cannot be achieved within a desired period of time.

Furthermore, according to the conventional data distribution system, for example, when an ES used to construct a scene fails to reach the receiving terminal 108, the reason why the ES has failed to reach the receiving terminal 108 cannot be judged. Specifically, it cannot be judged whether the ES processing unit 103 in the server 100 intends the failure to reach the receiving terminal 108, the ES is lost as a transmission loss, or the ES has not yet reached the receiving terminal 108 because of a delay in transmission.

On the other hand, a scene description may be distributed over a transmission line whose bandwidth is not constant but varies depending on a time or a channel. Otherwise, a scene description may be distributed to an unspecified large number of receiving terminals whose specifications are not predefined and whose processing abilities are different from one another. In this case, the server 100 in the conventional data distribution system has difficulty in determining an optimal scene construction in advance. In addition, a decoding unit in a receiving terminal may be realized with software, and the software of the decoding unit and software responsible for processing other than decoding may share the same CPU or memory. In this case, the processing ability of the decoding unit may vary dynamically. The server 100 cannot therefore determine an optimal scene construction in advance.

Moreover, in the case of the conventional data distribution system, the receiving terminal 108 may receive a scene construction that is too complex to decode an ES according to the scene construction and display a scene using the resultant ES. Otherwise, the receiving terminal 108 may receive a scene description that describes numerous ESs. In this case, decoding the ESs and decoding the scene description are not completed in time. Consequently, decoding and display may become asynchronous or a memory in which input data is stored temporarily may be overflowed. As a conceivable countermeasure, input data that cannot be processed by the receiving terminal 108 may be discarded. However, this leads to a fear that important data needed to construct a scene may be lost. Besides, a bandwidth is allocated in vain to transmission of data that is not used for image display. There is therefore a demand for the server 100 capable of distributing a scene description that conforms to the decoding ability or display ability of the receiving terminal 108. At present, such a server is unavailable.

### SUMMARY OF THE INVENTION

The present invention attempts to break through the foregoing situation. An object of the present invention is to provide a data transmission system, a data transmitting apparatus and method, and a scene description processing unit and method in which a scene description that conforms to the state of a transmission line or the processing ability of a receiving terminal can be transmitted to the receiving terminal. Moreover, a drawback such as unexpected missing of part of a scene which is not intended by a transmitting side is prevented from stemming from a loss that occurs on a transmission line or the insufficient processing ability of a receiving terminal. Even when a bit rate at which an ES is transmitted is changed, the receiving terminal can decode the ES according to a scene construction that conforms to the bit rate, and display a scene using the resultant ES. Furthermore, a change in information needed to decode the ES can be explicitly reported to the receiving terminal. Consequently, the receiving terminal need not sample the information, which is needed to decode the ES, from the ES itself.

According to the present invention, there is provided a data transmission system consisting mainly of a transmitting apparatus and a receiving apparatus. The transmitting apparatus transmits a scene description that describes the structures of one or more signals to be used to construct a scene. The receiving apparatus constructs the scene according to the scene description. The transmitting apparatus includes a scene description processing means that transfers a scene description that conforms to the state of a transmission line or a request issued from the receiving apparatus. The data transmission system thus accomplishes the aforesaid object.

Moreover, according to the present invention, there is provided a data transmitting method for transmitting a scene description, which describes the structures of one or more signals to be used to construct a scene, and constructing the scene according to the scene description. According to the data transmitting method, a scene description that conforms to the state of a transmission line and/or a request issued from a receiving side is transmitted. The data transmitting method thus accomplishes the aforesaid object.

Next, according to the present invention, there is provided a data transmitting apparatus for transmitting a scene description that describes the structures of one or more signals to be used to construct a scene. The data transmitting apparatus includes a scene description processing means for transferring a scene description that conforms to the state of a transmission line and/or a request issued from a receiving side. Consequently, the data transmitting apparatus accomplishes the aforesaid object.

Moreover, according to the present invention, there is provided a data transmitting method for transmitting a scene description that describes the structures of one or more signals to be used to construct a scene. According to the data transmitting method, a scene description that conforms to the state of a transmission line and/or a request issued from a receiving side is transmitted. The data transmitting method thus accomplishes the aforesaid object.

Next, according to the present invention, there is provided a scene description processing unit for processing a scene description that describes the structures of one or more signals to be used to construct a scene. Herein, when a scene description must be transmitted over a transmission line, a scene description that conforms to the state of a transmission line and/or a request issued from a receiving side is transferred. The scene description processing unit thus accomplishes the aforesaid object.

Moreover, according to the present invention, there is provided a scene description processing method for processing a scene description that describes the structures of one or more signals to be used to construct a scene. According to the scene description processing method, when a scene description must be transmitted over a transmission line, a scene description that conforms to the state of the transmission lien and/or a request issued from a receiving side is transferred. The scene description processing method thus accomplishes the aforesaid object.

According to the present invention, for example, a server for distributing data includes a scene description processing means that dynamically processes a scene description in conformity with the state of a transmission line or a request for transmission issued from a receiving terminal. The server then transmits a scene description, which conforms to the state of the transmission line or the processing ability of the receiving terminal, to the receiving terminal. Herein, a bit rate at which an ES is transmitted may be changed based on the state of the transmission line or receiving terminal. In this case, a scene description optimal to the ES for which the bit rate has been changed is transmitted. Consequently, the receiving terminal can decode the ES according to a scene construction suitable for the bit rate for the ES. Moreover, a bit rate at which an ES is transmitted may be changed based on the state of the transmission line or receiving terminal, and information needed to decode the ES may be modified accordingly. In this case, a scene description that includes the information needed to decode the ES is modified accordingly. This relieves the receiving side of the necessity of sampling information, which is needed for decoding, from the ES. Furthermore, since a scene description that explicitly describes an ES to be used to construct a scene is transmitted to the receiving terminal, the receiving terminal can judge whether the ES is needed to construct a scene, irrespective of a delay in arrival of the ES at the receiving terminal or a loss in data. Moreover, a bit rate at which a scene description is transmitted is controlled based on the state of the transmission line, whereby a delay in data transmission or a loss in data is prevented from occurring on the transmission line. Moreover, when the ability of the receiving terminal dynamically varies, the server modifies a scene description and then transmits the resultant scene description. Consequently, important part of a scene description is prevented from being discarded at the receiving terminal unintentionally to the server. When it says that a scene description is modified, it means that a scene description is selected from among a plurality of predefined scene descriptions and then transferred. Otherwise, a predefined scene description is received, and converted into a scene description that conforms to the state of a transmission line or the ability of a receiving terminal. Otherwise, a scene description is produced or encoded in conformity with the state of a transmission line or the ability of a receiving terminal, and then transmitted.

### BRIEF DESCRIPTION OF THE DRAWINGS

FIG. 1 is a block diagram showing the outline configuration of a data distribution system in accordance with an embodiment of the present invention;

FIG. 2 shows a result of scene display performed based on a scene description that has not been modified during first scene description processing employed in the present embodiment;

FIG. 3 shows an example of a scene description (written in compliance with the MPEG-4 BIFS) describing the construction of a scene shown in FIG. 2;

FIG. 4 shows a result of scene display performed based on a scene description that has been modified during the first scene description processing employed in the present embodiment;

FIG. 5 is an explanatory diagram used to explain the timing of modifying ESs and the timing of modifying a scene description during the first scene description processing employed in the present embodiment;

FIG. 6 shows an example of a scene description (written in compliance with the MPEG-4 BIFS) describing the construction of the scene shown in FIG. 4;

FIG. 7 shows an example of information (described in ObjectDescriptor stipulated in the MPEG-4) that is appended to the scene description shown in FIG. 3 and that is needed to decode ESs that are used to construct the scene shown in FIG. 2;

FIG. 8 shows an example of information (described in ObjectDescriptor stipulated in the MPEG-4) that is appended to the scene description shown in FIG. 6 and that is needed to decode ESs which are used to construct the scene shown in FIG. 4;

FIG. 9 shows an example of a scene description (written in compliance with the MPEG-4 BIFS) describing the construction of a scene different from the scene described in conjunction with FIG. 2 and FIG. 3 in a point that a motion picture ES is unused;

FIG. 10 shows a result of display performed based on the scene description shown in FIG. 9;

FIG. 11 shows an example of a scene description (written in compliance with the MPEG-4 BIFS) according to which an object described as a polygon is displayed;

FIG. 12 shows an example of a scene description (written in compliance with the MPEG-4 BIFS) according to which a sphere is substituted for an object described as a polygon;

FIG. 13 shows a result of display performed based on the scene description shown in FIG. 11;

FIG. 14 shows a result of display performed based on the scene description shown in FIG. 12;

FIG. 15 shows an example of a scene description (written in compliance with the MPEG-4 BIFS) describing the construction of a scene composed of four objects;

FIG. 16 shows a result of display performed according to the scene description shown in FIG. 15;

FIG. 17 shows an example of four AUs (written in compliance with the MPEG-4 BIFS) into which the scene description shown in FIG. 15 is divided;

FIG. 18 is an explanatory diagram used to explain the timing of decoding each AU shown in FIG. 17;

FIG. 19 shows a result of display performed based on the scene description composed of the AUs shown in FIG. 17; and

FIG. 20 is a block diagram showing the outline configuration of a conventional data distribution system.

### DESCRIPTION OF THE PREFERRED EMBODIMENTS

A preferred embodiment of the present invention will be described with reference to the drawings below.

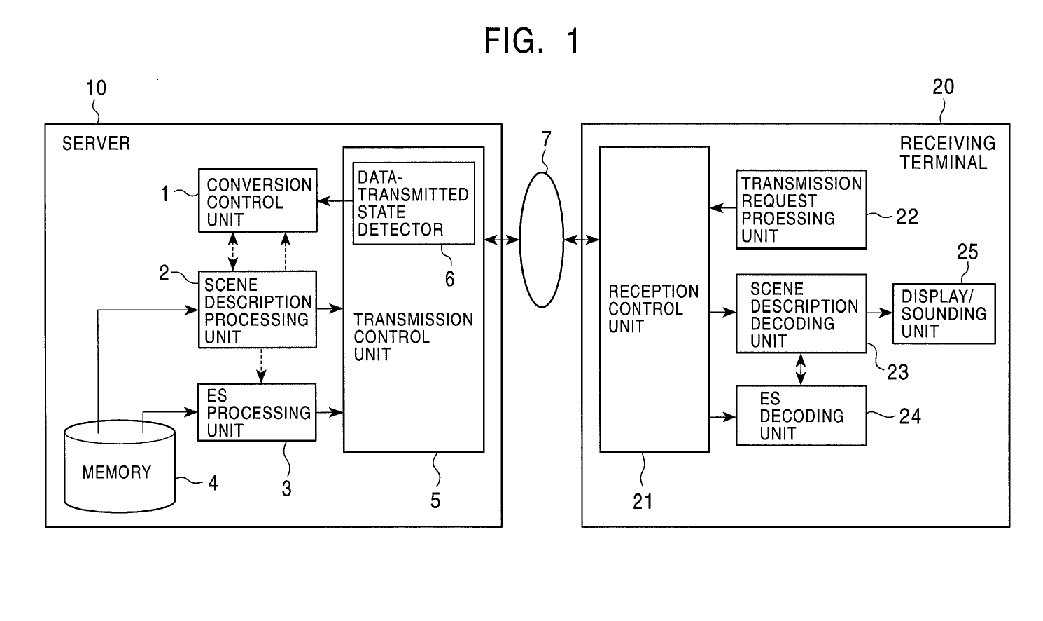

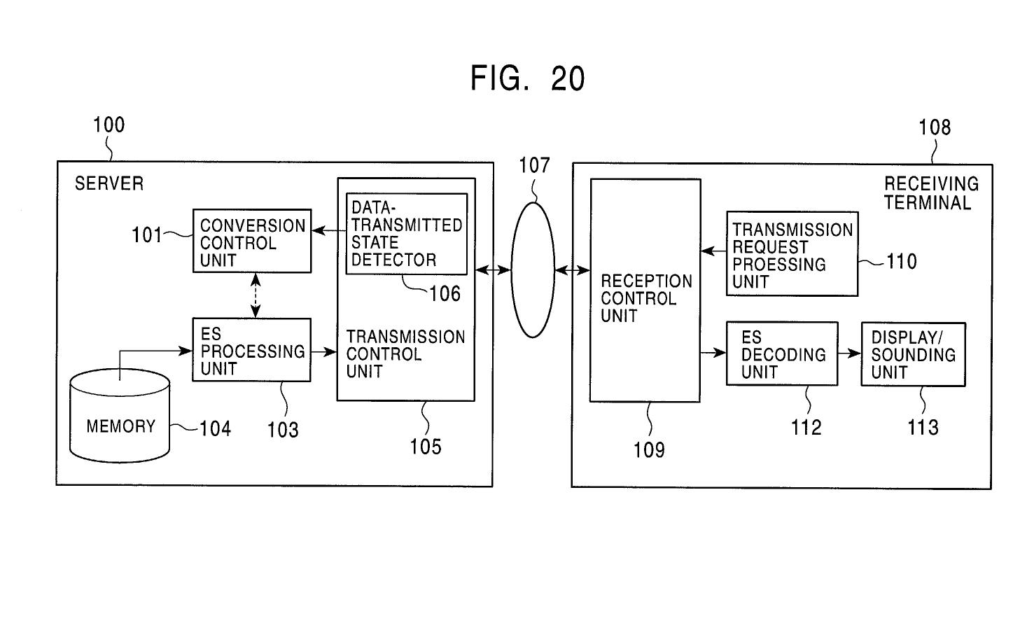

FIG. 1 shows an example of the configuration of a data distribution system in accordance with the present embodiment. Compared with the conventional data distribution system shown in FIG. 20, the data distribution system in accordance with the present embodiment accommodates a server 10 that includes a scene description processing unit 2. Moreover, a receiving terminal 20 includes a scene description decoding unit 23 that decodes a scene description received from the scene description processing unit 2 (that is, interprets the scene description to construct a scene). Scene description processing to be performed by the scene description processing unit 2 will be detailed later.

Referring to FIG. 1, an ES processing unit 3 included in the server 10 selects any of ESs stored in advance in a memory 4. Otherwise, the ES processing unit 3 receives a baseband image signal and acoustic signal, which are not shown, and encodes the signals to produce an ES. At this time, a plurality of ESs may be produced. A transmission control unit 5 included in the server 10 multiplexes the plurality of ESs if necessary, encodes a resultant ES according to a protocol according to which a signal is transmitted over a transmission medium 7, and transmits the ES to the receiving terminal 20.

A reception control unit 21 included in the receiving terminal 20 decodes the ES, which has been transmitted over the transmission medium 7, according to the protocol, and hands the resultant ES to an ES decoding unit 24. If ESs are multiplexed, the reception control unit 21 separates the ESs, and hands the ESs to associated ES decoding units 24. The ES decoding unit 24 decodes an ES to restore an image signal and an acoustic signal. The image signal and acoustic signal produced by the ES decoding unit 24 are sent to a scene description decoding unit 23. The scene description decoding unit 23 constructs a scene using the image signal and acoustic signal according to a scene description transmitted from the scene description processing unit 2 that will be described later. A signal representing the scene is transferred to a display sounding unit 25 composed of a television monitor and a loudspeaker. Consequently, an image expressing the scene is displayed on the television monitor, and sounds expressing the scene are radiated from the loudspeaker.

The server 10 corresponds to a transmission system installed at a broadcasting station that provides a broadcasting service, or an Internet server or home server that gives access to the Internet. The receiving terminal 20 corresponds to a receiving apparatus for receiving a broadcast signal or a personal computer. The transmission medium 7 corresponds to a leased transmission line accommodated by a broadcasting system or a fast communication network included in the Internet.

Moreover, the data distribution system in accordance with the present embodiment performs actions described below to overcome a drawback that a change in the bandwidth of a transmission line (transmission medium 7) over which an ES is transmitted or a change in the traffic-jammed state on the transmission line leads to a delay in data transmission or a loss in transmitted data.

The server 10 (for example, the transmission control unit 5) assigns a (encoded) serial number to each packet in the form of which data is transmitted over a transmission line. The reception control unit 21 in the receiving terminal 20 monitors a packet received over the transmission line to see if a (encoded) serial number that should be assigned to each packet is missing, and thus detects a loss in data (a data loss rate). Otherwise, the server 10 (for example, the transmission control unit 5) appends (encoded) time instant information to data to be transmitted over the transmission line. The reception control unit 21 in the receiving terminal 20 monitors data received over the transmission line to see if (encoded) time instant information is appended to the data, and thus detects a delay in transmission in terms of the time instant information. The reception control unit 21 in the receiving terminal 20 thus detects the data loss rate on the transmission line or the delay in transmission thereon. The reception control unit 21 then transmits (reports) the detected information to the data-transmitted state detector 6 included in the server 10.

The data-transmitted state detector 6 in the server 10 receives the information of the data loss rate that characterizes the transmission line or the delay in transmission occurring on the transmission line from the reception control unit 21 in the receiving terminal 20. The data-transmitted state detector 6 thus detects a bandwidth offered by the transmission line or the traffic-jammed state of the transmission line. In other words, if a data loss is large, the data-transmitted state detector 6 judges that the transmission line is jammed. If a transmission line of a bandwidth reservation type is adopted, the data-transmitted state detector 6 can detect an available bandwidth usable by the server 10. If a transmission medium dependent on weather conditions such as radio waves is adopted, a user may designate a bandwidth in advance. The information of the data-transmitted state detected by the data-transmitted state detector 6 is sent to the conversion control unit 1.

Based on the detected information of the bandwidth of the transmission line or the traffic-jammed state thereof, the conversion control unit 1 controls the ES processing unit 3 so that the ES processing unit 3 will switch ESs which are transmitted at different bit rates. Otherwise, when the ES processing unit encodes an ES according to the ISO/IEC13818 (so-called MPEG2), the encoding rate is controlled. In other words, if it is detected that the transmission line is jammed, the ES processing unit 3 transfers an ES that must be transmitted at a low bit rate. Consequently, a delay in data transmission can be avoided.

Moreover, for example, an unspecified large number of receiving terminals 20 may be connected to the server 10, and the specifications for the receiving terminals 20 may not be uniform. Besides, the server 10 may have to transmit an ES to the receiving terminals 20 whose processing abilities are different from one another. In this case, each of the receiving terminals 20 includes a transmission request processing unit 22. The transmission request processing unit 22 produces a transmission request signal with which an ES that conforms to the processing ability of the own receiving terminal 20 is requested. The transmission request signal is transmitted from the reception control unit 21 to the server 10. The transmission request signal includes a signal that expresses the ability of the own receiving terminal 2. The signal that expresses the ability of the own receiving terminal 2 and that is transferred from the transmission request processing unit 22 to the server 10 is a signal representing, for example, a memory size, a resolution offered by the display unit, an arithmetic capability, a buffer size, an ES encoding format that permits decoding, the number of decodable ESs, or a bit rate for a decodable ES. In response to the transmission request signal, the conversion control unit 1 in the server 10 controls the ES processing unit 3 so that the ES processing unit 3 will transmit an ES that conforms to the performance of the receiving terminal 20. Talking of image signal conversion for converting an ES into another ES that conforms to the performance of the receiving terminal 20, for example, an image signal converting method the present applicant has already proposed may be adopted.

The aforesaid components and actions are identical to those of the example shown in FIG. 20. In the data distribution system of the present embodiment, the conversion control unit 1 in the server 10 controls not only the ES processing unit 3 but also the scene description processing unit 2 according to the state of the transmission line detected by the data-transmitted state detector 6. Moreover, if the receiving terminal 20 is a receiving terminal that requests a scene description which conforms to the decoding and display abilities thereof, the conversion control unit 1 in the server 10 controls the ES processing unit 3 and scene description processing unit 2 according to a signal that expresses the ability of the receiving terminal and that is sent from the transmission request processing unit 22 in the receiving terminal 20. In other words, the scene description processing unit 2 employed in the present embodiment performs five kinds of scene description processing of first to fifth scene description processing, which will be described below, under the control of the conversion control unit 1.

The first to fifth scene description processing employed in the present embodiment will be described below.

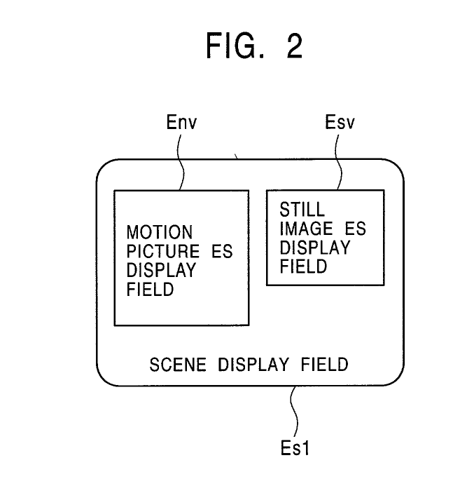

To begin with, the first scene description processing will be described. The server 10 employed in the present embodiment can transfer a scene description suitable for an ES produced by the ES processing unit 3. In other words, the scene description processing unit 2 employed in the present embodiment can produce a scene description, which is suitable for an ES produced by the ES processing unit 3, under the control of the conversion control unit 1. The first scene description processing will be described concretely in conjunction with FIG. 2 to FIG. 6.

FIG. 2 shows an example of displaying a scene constructed using a motion picture ES and a still image ES. Referring to FIG. 2, there is shown a scene display field Esi. A motion picture ES display field EmV is contained in the scene display field Esi, and a still image ES display field Esv is also contained in the scene display field Esi.

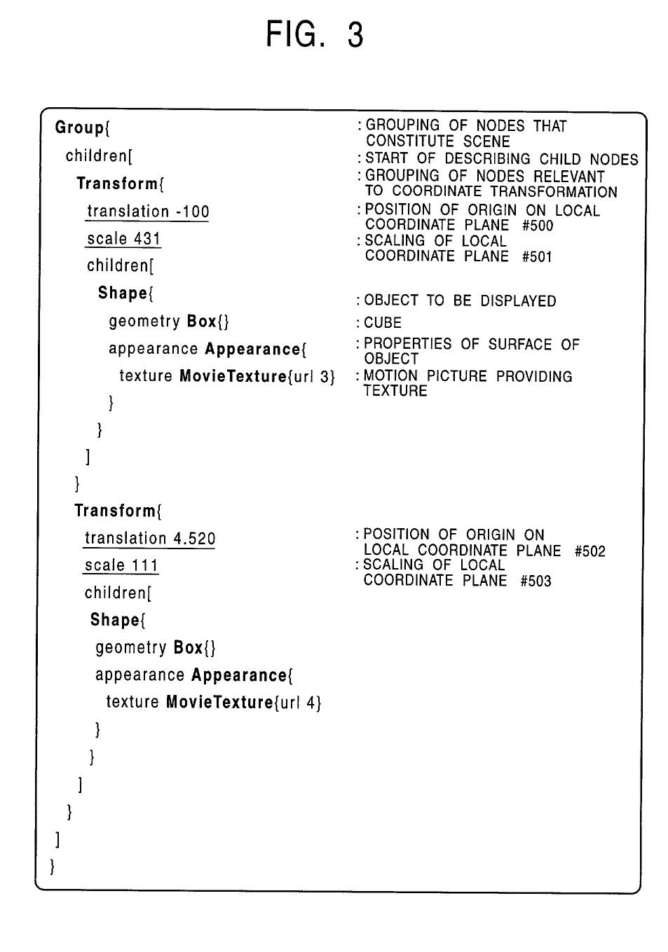

FIG. 3 shows a scene description that describes the construction of a scene to be displayed in the scene display field Esi. The scene description is written in compliance with the MPEG-4 BIFS. The adoption of the VRML results in a scene description written as text data, while the adoption of the MPEG-4 BIFS results in a scene description written as binary-encoded text data. If the scene description shown in FIG. 2 is written in compliance with the MPEG-4 BIFS, the scene description is binary-coded in reality. However, FIG. 3 shows the scene description written in the form of text for a better understanding. A method of writing a scene description in compliance with the MPEG-4 BIFS is stipulated in the ISO/IEC14496-1, and the description of the method will therefore be omitted.

A scene description written in compliance with the MPEG-4 BIFS (or VRML) is expressed using a basic description unit that is referred to as a node. Referring to FIG. 3, a node is written with bold characters. The node is a unit that describes an object to be displayed or a connection between objects, and contains data that is referred to as a field and that expresses the property or attribute of the node. For example, a node “Transform” in FIG. 3 is a node that specifies three-dimensional coordinate transformation. A field “translation” subordinate to the node “Transform” specifies a magnitude of parallel movement of an origin in a coordinate plane. Moreover, some fields point out other nodes. For example, the node “Transform” in FIG. 3 contains a field “children” that specifies a group of child nodes. The child nodes specify an object to be subjected to coordinate transformation. For example, a node “Shape” and others are grouped into the field “children.” In order to arrange objects to be displayed in a scene image, a node that specifies an object and nodes that specify the attributes of the object are grouped together, and grouped under a node that specifies a position at which the object should be located. For example, an object specified in a node “Shape” in FIG. 3 is subjected to parallel movement as specified in the parent node “Transform” and then arranged in a scene. Moreover, video data and audio data are arranged spatially and temporally according to a scene description, and then made visible and audible. For example, a node “MovieTexture” in FIG. 3 specifies that a cube is displayed with a motion picture identified with an identification (ID) number of 3 pasted to the surface thereof.

The scene description shown in FIG. 3 describes that a scene contains two cubes and that a motion picture and a still image are pasted to the surfaces of the cubes in order to express the textures of the surfaces. Coordinate transformation is specified for each of the objects in the node “Transform.” The object is moved in parallel according to a value specified in a field “translation” indicated with #500 or #502 in FIG. 3 (an origin in a local coordinate plane). Moreover, enlargement or reduction of the object specified in the node “Shape” subordinate to the node “Transform” is specified with a value indicated with #501 or #503 (scaling down or up of a local coordinate plane).

For example, assume that a bit rate at which data is transmitted must be lowered due to the state of a transmission line or a request issued from a receiving terminal. In this case, for example, a motion picture ES is modified in order to lower a bit rate for the motion picture ES. This because when it says that a motion picture ES is transmitted, it means that a large amount of data must be transmitted. Incidentally, at this time, for example, a high-resolution still image ES has already been transmitted and stored in the receiving terminal.

In this case, the conventional data distribution system decodes an ES according to the same scene construction irrespective of whether a bit rate for the ES has been controlled, and then displays an image using the resultant ES. Therefore, when a motion picture is displayed based on the motion picture ES for which a bit rate has been lowered, poor image quality or the like becomes distinctive. Taking the example shown in FIG. 2, a description will be made concretely below. Specifically, in the conventional data distribution system, even when a bit rate for a motion picture ES based on which a motion picture is displayed in the motion picture ES display field Emv in FIG. 2 is lowered or anyhow controlled, the ES is decoded according to the same scene construction as an ES for which a bit rate is not controlled is. A motion picture is then displayed based on the resultant ES. In other words, the motion picture ES is decoded so that the motion picture will be displayed while occupying the entire motion picture ES display field Emv that is too wide for an actual bit rate. Consequently, the motion picture displayed based on the motion picture ES appears rough (for example, appears to exhibit a low spatial resolution). Poor image quality is distinctive.

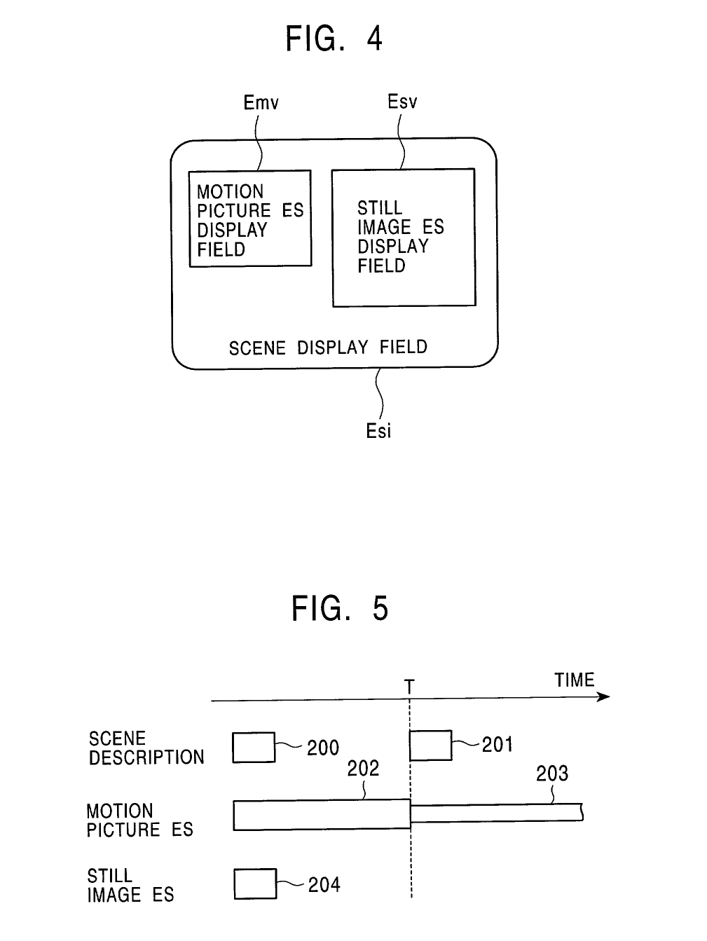

In contrast, when a bit rate for a motion picture ES is lowered, the motion picture ES display field Emv may be narrowed as shown in FIG. 4. In this case, poor image quality of a motion picture displayed in the motion picture ES display field Emv (in this case, a low spatial resolution) may become indistinctive. Moreover, according to the present embodiment, a still image ES is already transmitted and stored in the receiving terminal. If a still image represented by the still image ES is, for example, a high-resolution image, the still image ES display field Esv in FIG. 2 may be too narrow for the resolution. In this case, the still image ES display field Esv may be made wider as shown in FIG. 4. Thus, the high resolution of the still image can be fully utilized. In order to thus narrow the motion picture ES display field Em or widen the still image ES display field Esv, a scene description must be modified to describe such a scene construction.

The scene description processing unit 2 employed in the present embodiment dynamically modifies a scene description according to whether the ES processing unit 3 has controlled a bit rate for an ES. In other words, when the conversion control unit 1 in the server 10 employed in the present embodiment instructs the ES processing unit 3 to control a bit rate for an ES, the conversion control unit 1 also instructs the scene description processing unit 2 to produce a scene description suitable for the ES to be transferred from the ES processing unit 3. Consequently, according to the present embodiment, even when a bit rate for a motion picture is lowered, deteriorated image quality is indistinctive. According to the present embodiment, the motion picture ES display field Emv is narrowed as shown in FIG. 4, while the still image ES display field Esv is widened in order to make the most of the high resolution of a still image whose signal has already been transmitted.

Referring to FIG. 5, a description will be made of concrete actions to be performed by the conversion control unit 1 in order to implement the above feature.

If a bit rate at which data is transmitted must be lowered due to the state of a transmission line or a request issued from a receiving terminal, the conversion control unit 1 controls the ES processing unit 3 so that the ES processing unit will produce a motion picture ES 203, which will be transmitted at a lower bit rate than a motion picture ES 202 is, at a time instant T in FIG. 5.

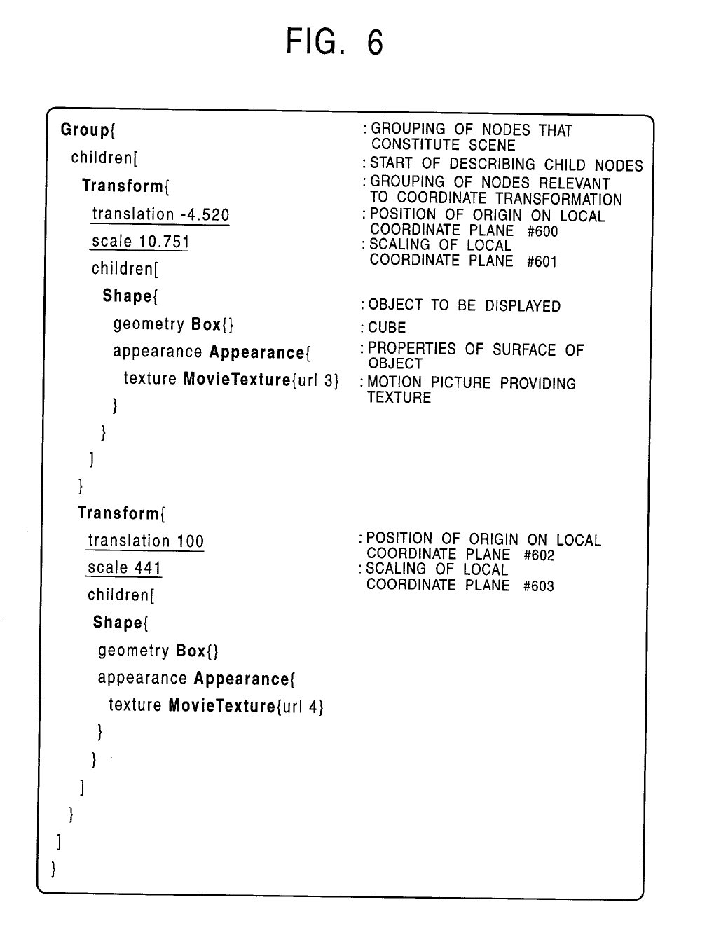

Moreover, the conversion control unit 1 controls the scene description processing unit 2 so that the scene description processing unit 2 will convert a scene description 200 into a scene description 201. Herein, the scene description 200 describes the construction of a scene that appears in the scene display field Esi shown in FIG. 2, while the scene description 201 describes the construction of a scene that appears in the scene display field Esi shown in FIG. 4. Specifically, the scene description processing unit 2 converts the scene description, which is shown in FIG. 3 and describes the construction of the scene that appears in the scene display field Esi shown in FIG. 2, into the scene description which is shown in FIG. 6 and which describes the construction of the scene that appears in the scene display field Esi shown in FIG. 4. The scene description shown in FIG. 6 is, like the one shown in FIG. 3, a text version of an actual scene description written in compliance with the MPEG-4 BIFS.

Compared with the scene description shown in FIG. 3, in the scene description shown in FIG. 6, values specified in the fields “translation” indicated with #600 and #602 in the drawing are different from the values specified in the scene description shown in FIG. 3. Namely, two cubes are moved according to the values specified in the fields “translation” indicated with #600 and #602. One of the cubes having a motion picture (displayed in the field Emv in FIG. 4) pasted to the surface thereof is converted to a smaller cube according to the value specified in the field “scale” indicated with #601. The other cube having a still image (displayed in the field Esv in FIG. 4) pasted to the surface thereof is converted into a larger cube according to a value specified in the field “scale” indicated with #603.

For example, the conversion of the scene description shown in FIG. 3 into the scene description shown in FIG. 6, which is performed during the aforesaid first scene description processing, is realized with any of actions performed by the scene description processing unit 2 as described below. Namely, a scene description (the scene description shown in FIG. 6) suitable for an ES produced by the ES processing unit 3 is selected from among a plurality of scene descriptions stored in advance in the memory 4, and then transmitted. Otherwise, a scene description (the scene description shown in FIG. 3) read from the memory 4 is converted into a scene description (the scene description shown in FIG. 6) suitable for an ES produced by the ES processing unit 3, and then transmitted. Otherwise, a scene description (the scene description shown in FIG. 6) suitable for an ES produced by the ES processing unit 3 is produced or encoded and then transmitted. When a scene description form permits description of a portion of a scene description that must be modified, the portion alone may be modified and transmitted. In the aforesaid example, when a bit rate for a motion picture ES is lowered, the motion picture ES display field Emv is narrowed. In contrast, when a bit rate is raised, the motion picture ES display field Emv may be widened. Even to this case, the feature of the present invention for modifying the scene description can be adapted. Furthermore, in the aforesaid example, a still image ES that represents a high resolution is transmitted in advance. For example, when a still image whose signal has already been transmitted and stored exhibits a low resolution, a high-resolution still image ES may be newly transmitted, and a scene description suitable for the still image ES may be transmitted. According to the present embodiment, a motion picture and a still image are taken for instance. The present invention is also applied to a case where a scene description is modified because a bit rate for other multimedia data has been controlled.

According to the first scene description processing described in conjunction with FIG. 2 to FIG. 6, a scene description that is data describing a scene construction is modified. Consequently, a scene description that conforms to the state of a transmission line or a request issued from a decoding terminal can be transmitted. Moreover, when the ES processing unit 3 modifies an ES, a scene description suitable for the resultant ES can be transmitted.

Next, second scene description processing will be described below.

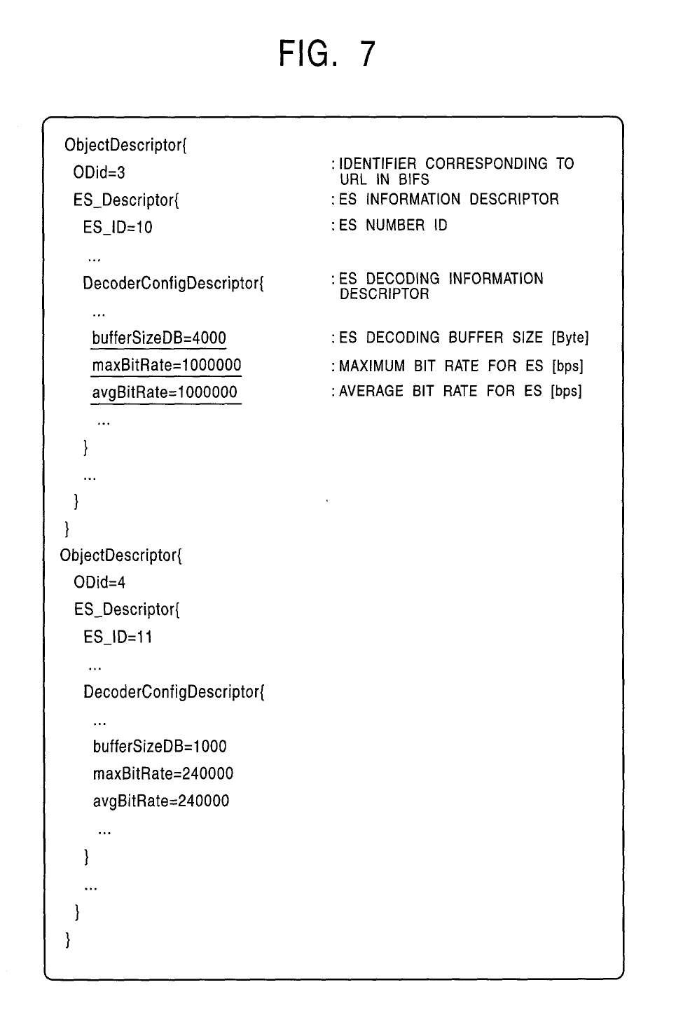

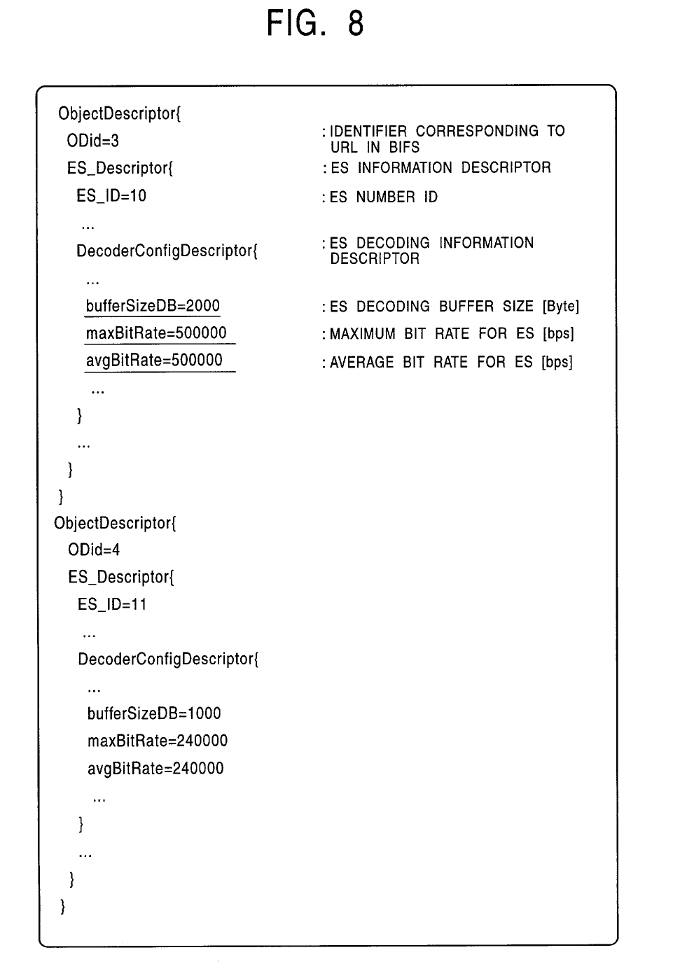

For example, when the ES processing unit 3 changes a bit rate for an ES according to the state of a transmission line or the state of the receiving terminal 20, information needed to decode the ES may be modified. In this case, the server 10 employed in the present embodiment converts a scene description which includes the information needed to decode the ES and transmits the resultant scene description. The conversion and transmission are performed as second scene description processing. This relieves a receiving terminal of the necessity of sampling information, which is needed to decode an ES, from the ES itself, though the receiving terminal in the conventional data distribution system has to perform the sampling. Specifically, when information needed to decode an ES is modified because the ES processing unit 3 has modified the ES, the scene description processing unit 3 employed in the present embodiment produces a scene description that includes the information needed to decode the ES. Incidentally, information needed to decode an ES includes, for example, an ES encoding format, a buffer size required for decoding, and a bit rate. Referring to the drawings referred to previously as well as FIG. 7 and FIG. 8, the second scene description processing will be described concretely below.

FIG. 7 shows an example of information needed to decode an ES that is used to display a scene like the one described in conjunction with FIG. 2 and FIG. 3, and that is described in a descriptor “ObjectDescriptor” stipulated in the MPEG-4. In the scene description shown in FIG. 3, the motion picture to be mapped to the surface of the object in order to express the texture of the surface is specified with a value of 3 (=ur13). The value corresponds to the value of an identifier (0Did=3) subordinate to the descriptor “ObjectDescriptor” shown in FIG. 7. A descriptor “ES_Descriptor” subordinate to the “ObjectDescriptor” concerning the object identified with the identifier “0Did=3” describes information concerning an ES. Moreover, “ES_ID” in FIG. 7 is an identifier unique to an ES. The identifier “ES_ID” is related to an identifier of a header or a port number that is appended to an ES as defined in a protocol adopted for transmission of an ES, and thus associated with an actual ES.

Moreover, the descriptor “ES_Descriptor” contains a descriptor “DecoderConfigDescriptor” that describes information needed to decode an ES. The information described in the descriptor “DecoderConfigDescriptor” includes, for example, a buffer size needed to decode an ES, a maximum bit rate, and an average bit rate.

FIG. 8 shows an example of information that is needed to decode an ES and that is appended to a scene description that has been modified by the scene description processing unit 2. The scene description describes the construction of the scene shown in FIG. 4. The information needed to decode an ES is described using a descriptor “ObjectDescriptor” stipulated in the MPEG-4. Since the identifier 0Did specifies 3, it is judged from the scene description that the descriptor describes information needed to decode a motion picture ES. Since the motion picture ES is modified, a decoding buffer size specified in “bufferSizeDB,” a maximum bit rate specified in “maxBitRate,” and an average bit rate specified in “avgBitRate” which are described in the descriptor “ObjectDescriptor” shown in FIG. 7 are changed to those described in the descriptor “ObjectDescriptor” shown in FIG. 8. In other words, in the example shown in FIG. 7, 4000 is specified in “bufferSizeDB,” 1000000 is specified in “maxBitRate,” and 1000000 is specified in “avgBitRate.” Referring to FIG. 8, 2000 is specified in “bufferSizeDB,” 5000000 is specified in “maxBitRate,” and 5000000 is specified in “avgBitRate.”

The modification of information needed to decode an ES and appended to a scene description, which is performed during the second scene description processing, is realized with any of actions performed by the scene description processing unit 2 as described below. Namely, information associated with an ES produced by the ES processing unit 3 (information shown in FIG. 8) is selected from among a plurality of information items needed to decode ESs, and then transmitted. Herein, the plurality of information items needed to decode ESs is stored in the memory 4 in advance. Otherwise, information needed to decode an ES (information shown in FIG. 7) is read from the memory 4, converted into information needed to decode an ES produced by the ES processing unit 3, and then transmitted. Otherwise, information needed to decode an ES produced by the ES processing unit 3 is encoded and then transmitted.

When a bit rate for an ES is changed in conformity with the state of the transmission line or the state of the receiving terminal 20, information needed to decode the ES is modified. In this case, according to the aforesaid second scene description processing, information needed to decode an ES and appended to a scene description is modified as shown in FIG. 8, and transmitted to the receiving terminal 20. This relieves the receiving terminal 20 of the necessity of sampling information needed to decode an ES from the ES.

Next, third scene description processing will be described below.

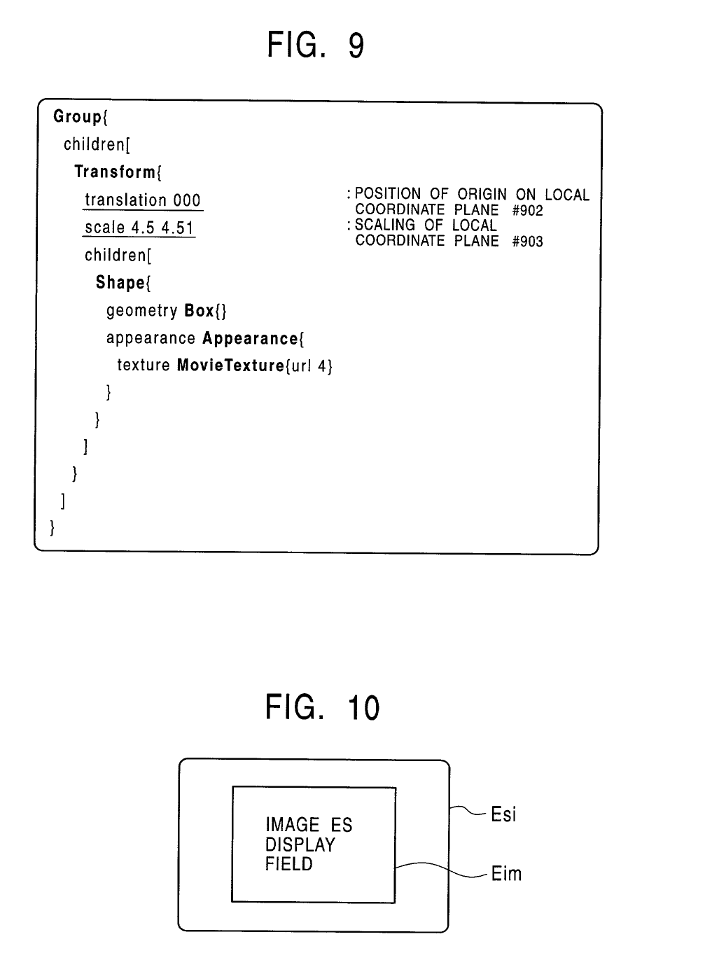

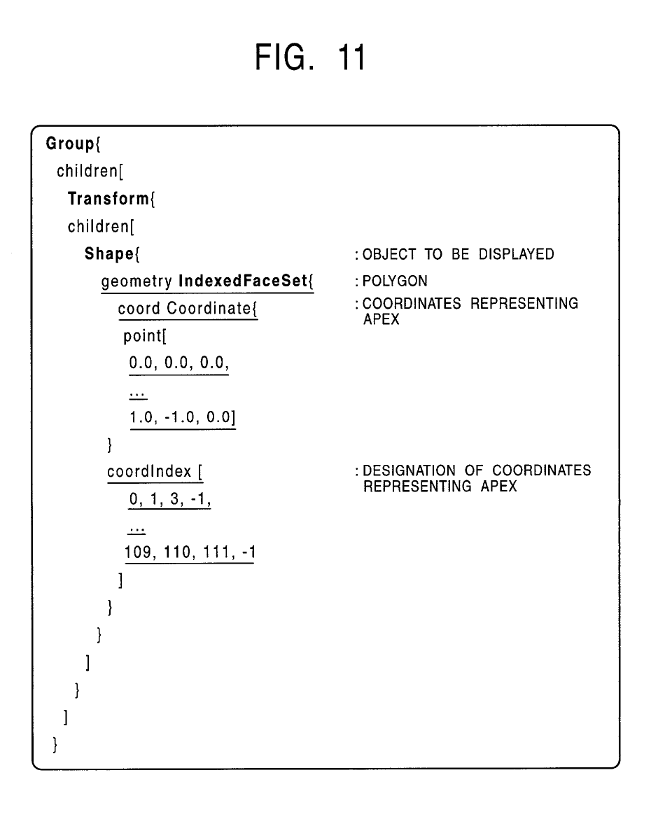

During the third scene description processing, the server 10 employed in the present embodiment explicitly modifies a scene description to increase or decrease the number of ESs used to construct a scene, and transfers the resultant scene description. Consequently, only an ES whose frequency falls within the bandwidth of a transmission line is transmitted. On the other hand, irrespective of a delay in arrival of an ES or a loss in data, the receiving terminal 20 judges whether an ES is needed to display a scene. Specifically, the scene description processing unit 3 included in the server 10 employed in the present embodiment explicitly modifies a scene description to increase or decrease the number of ESs under the control of the conversion control unit 1, and transfers the resultant scene description. Irrespective of a delay in arrival of an ES or a loss in data, the scene description decoding unit 23 included in the receiving terminal 20 judges whether an ES is needed to display a scene. The third scene description processing will be described concretely in conjunction with the drawings referred to previously as well as FIG. 9 and FIG. 10.

FIG. 9 shows a scene description that is devoid of, for example, the description of the motion picture ES which is included in the scene description described in conjunction with FIG. 2 and FIG. 3, and that is written in compliance with the MPEG-4 BIFS (a text version). FIG. 10 shows an example of a scene displayed based on the scene description shown in FIG. 9. A scene display field Esi contains only an image ES display field (for example, a still image ES display field) Eim. It can be judged from the scene description shown in FIG. 9 that only an ES described in the scene description is an ES identified with the value of 4 specified in the identifier “ODid.” Even if a motion picture ES identified with the value of 3 specified in the identifier “ODid” does not arrive, the receiving terminal 20 can judge that it does not attribute to a delay in arrival of an ES or a loss in data. Since the descriptor “ObjectDescriptor” concerning an ES identified with the value of 3 in “0Did” like the one shown in FIG. 7 or FIG. 8 is deleted, it can be judged that a motion picture ES identified with the value of 3 specified in “0Did” is no longer needed.

During the third scene description processing, the receiving terminal 20 may issue a transmission request saying that it wants to have a processing load, which it must incur to decode scene data so as to construct a scene, reduced temporarily. In this case, the server 10 converts a scene description, for example, the one shown in FIG. 3 into the scene description shown in FIG. 9. Consequently, the receiving terminal 20 is explicitly informed of the fact that a motion picture need not be mapped into another object in a scene in order to express the texture of the object. This leads to a reduction in the processing load the receiving terminal 20 has to incur for decoding scene data.

The conversion of the scene description shown in FIG. 3 into the scene description shown in FIG. 9 which is performed during the third scene description processing is realized with any of actions performed by the scene description processing unit 2 as described below. Specifically, a scene description (scene description shown in FIG. 9) associated with the number of ESs produced by the ES processing unit 3 is selected from among a plurality of scene descriptions stored in advance in the memory 4, and then transmitted. Otherwise, a scene description is read from the memory 4, and converted into a scene description (scene description shown in FIG. 9) devoid of part data (contained in the scene description) that describes an ES which will not be transferred. The resultant scene description is then transmitted. Otherwise, when a scene description is encoded, part of the scene description that describes an ES which will not be transferred is not encoded.

As described so far, according to the related art, a scene description cannot be modified. When a processing load a receiving terminal must incur exceeds the processing ability of the receiving terminal, part of scene data may be lost unexpectedly, or display of a scene may be delayed. According to the third scene description processing employed in the present embodiment, a scene description is modified as mentioned above. Consequently, the receiving terminal 20 can restore a scene as intended by the server 10 at an intended timing. Moreover, according to the third scene description processing, the scene description processing unit 2 can delete part data of a scene description in ascending order of importance until the processing load conforms to the processing ability of the receiving terminal 20 or until the frequency of a signal representing the scene description falls within the bandwidth of a transmission line. Moreover, according to the third scene description processing, when the processing ability of the receiving terminal 20 has room for a heavier load, a more detailed scene description can be transmitted. Consequently, scene data suitable for the processing ability of the receiving terminal 20 can be decoded, and a scene can be displayed based on the scene data.

Next, fourth scene description processing will be described below.

During the fourth scene description processing, the server 10 employed in the present embodiment modifies the complexity of a scene description according to the state of a transmission line or a request issued the receiving terminal 20. Thus, the amount of data of a scene description is adjusted, and the processing load the receiving terminal 20 incurs is adjusted. Specifically, the scene description processing unit 3 employed in the present embodiment adjusts the amount of data of a scene description in conformity with the state of a transmission line and a request issued from the receiving terminal 20 under the control of the conversion control unit 1, and then transmits the resultant scene description. The fourth scene description processing will be described concretely in conjunction with FIG. 11 to FIG. 14 below.

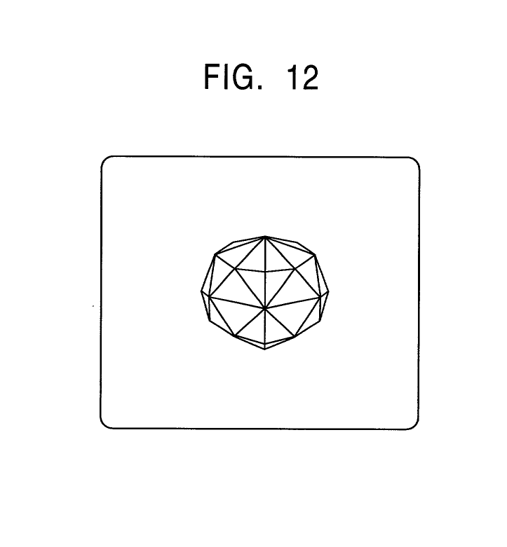

FIG. 11 shows a scene description that describes the construction of a scene which contains an object described as a polygon, and that is written in compliance with the MPEG-4 BIFS (a text version for a better understanding). For brevity's sake, coordinates representing the position of the polygon are omitted from the example of FIG. 11. In the scene description shown in FIG. 11, “IndexedFaceSet” describes a geometric object constructed by linking apexes, whose coordinates are specified in “point” subordinate to “Coordinate,” as orderly as specified in “CoordIndex.” Moreover, FIG. 12 shows an example of display of a scene achieved by decoding the scene description shown in FIG. 11 (an example of display of an object described as a polygon).

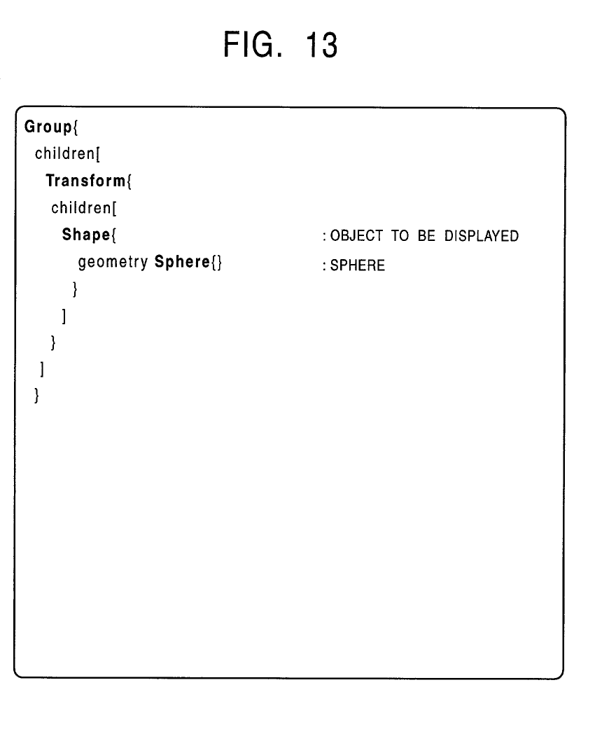

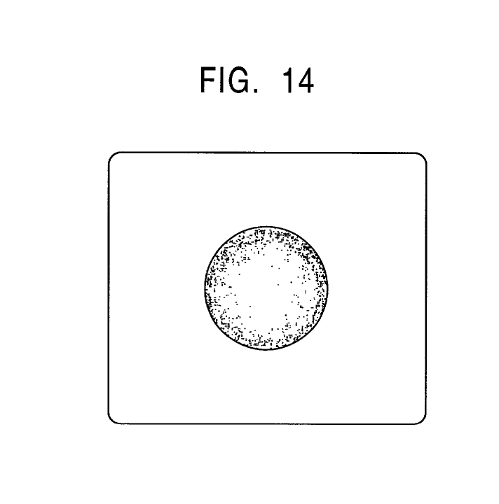

During the fourth scene description processing, an amount of data to be transmitted from the server 10 may have to be reduced due to the state of a transmission line, or a transmission request saying that the processing load must be reduced may be transmitted from the receiving terminal 20. In this case, the scene description processing unit 2 included in the server 10 converts a scene description into a simpler scene description. For example, the scene description in which “IndexedFaceSet” describes the polygon shown in FIG. 12 is converted into a scene description which is shown in FIG. 13 and in which “Sphere” describes a sphere like the one shown in FIG. 14. Consequently, the amount of data of the scene description itself is reduced, and the load the receiving terminal 20 incurs for decoding an ES and constructing a scene is lightened. In the case of the polygon shown in FIG. 12, values must be specified in order to express a polygon. In contrast, in the case of the sphere shown in FIG. 14, the values need not be specified. Therefore, the amount of data of the scene description that describes the construction of a scene containing the sphere is smaller. Moreover, the complex processing of displaying a polygon that is performed by the receiving terminal 20 is changed to the simpler processing of displaying a sphere. The processing load the receiving terminal 20 incurs is thus lightened.

The conversion of the scene description shown in FIG. 11 into the scene description shown in FIG. 13 which is performed during the fourth scene description processing is realized with any of actions performed by the scene description processing unit 2 as described below. Specifically, a scene description that meets a criterion defined based on the state of a transmission line or a request issued from the receiving terminal 20 is selected from among a plurality of scene descriptions stored in advance in the memory 4, and then transmitted. Otherwise, a scene description is read from the memory 4, and converted into a scene description that meets the criterion. Otherwise, a scene description that meets the criterion is encoded and then transmitted. What is referred to as the criterion is a criterion that implies the complexity of a scene description, such as, the amount of data of a scene description, the number of nodes, or the number of polygons.

Moreover, other methods of converting the complexity of a scene description which may be implemented in the scene description processing unit 2 will be described below. Namely, complex part data of a scene description may be replaced with simpler data like the one shown in FIG. 13. Otherwise, part data of a scene description is removed. When a scene description is encoded, a quantization step is modified in order to adjust the amount of data of a scene description. When it says that the quantization step of encoding is modified in order to adjust the amount of data of a scene description, for example, the number of bits to be quantized is decreased. This results in a decrease in the amount of data of a scene description. Incidentally, the MPEG-4 BIFS stipulates that a quantization parameter indicating whether quantization is adopted or not or the number of bits employed can be set for each quantization category, that is, coordinates, an inclination of an axis of rotation, or a size. Moreover, the quantization parameter can be changed within one scene description.

As described so far, according to the related art, a scene description cannot be modified. Therefore, when a processing load a receiving terminal must incur exceeds the processing ability of the receiving terminal, there is a fear that part of scene data may be lost unexpectedly. When the bandwidth of a transmission line is insufficient, there is a fear that part of data to be transmitted may be lost unexpectedly. According to the fourth scene description processing employed in the present embodiment, a scene description is modified so that a scene simplified as intended by the server 10 can be restored at the receiving terminal 20. Moreover, according to the fourth scene description processing, the scene description processing unit 2 can delete part data of a scene description in ascending order of importance until the frequency of a signal representing the scene description falls within the bandwidth of the transmission line or until the processing load the receiving terminal 20 must incur conforms to the processing ability of the receiving terminal 20.

Next, fifth scene description processing will be described below.

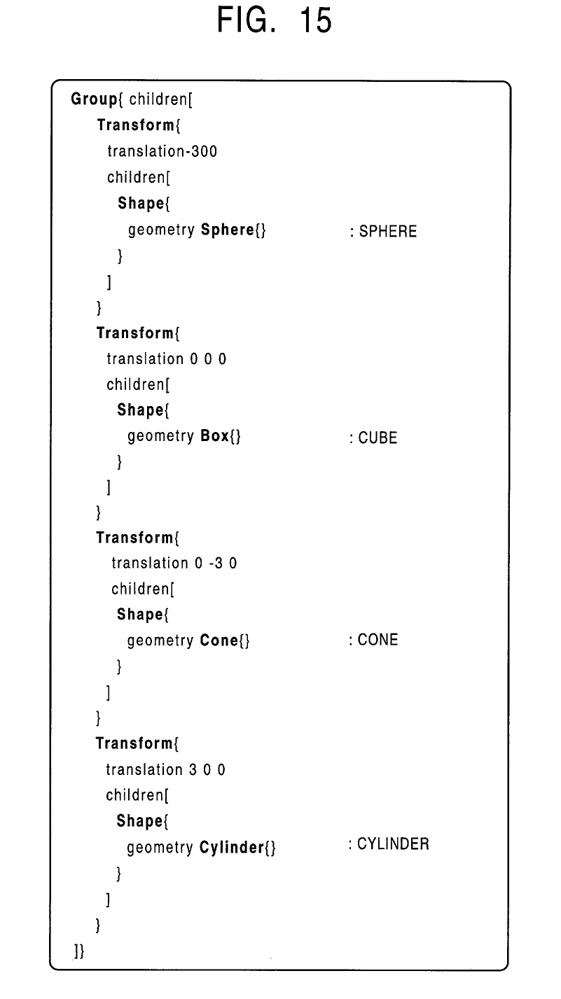

During the fifth scene description processing, the server 10 employed in the present embodiment divides a scene description into a plurality of decoding units in conformity with the state of a transmission line or a request issued from the receiving terminal 20. A bit rate for a scene description is adjusted, and local concentration of a processing load the receiving terminal 20 must incur is avoided. Specifically, the scene description processing unit 3 in accordance with the present embodiment divides a scene description into a plurality of decoding units in conformity with the state of the transmission line or the request issued from the receiving terminal 20 under the control of the conversion control unit 1. The scene description processing unit 3 transmits the scene description while adjusting the timing of transmitting each of the decoding units constituting the scene description. A decoding unit of the scene description that should be decoded at a certain time instant shall be referred to as an access unit (hereinafter, AU). Referring to FIG. 15 to FIG. 19, the fourth scene description processing will be concretely described below.

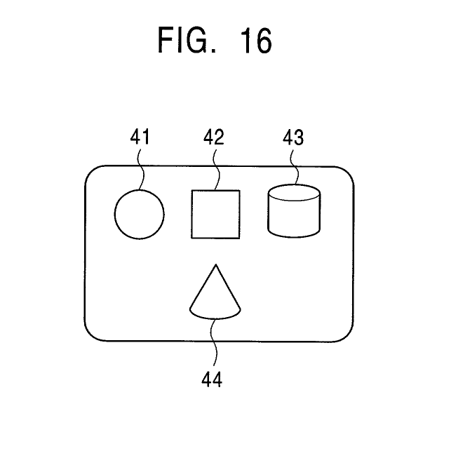

FIG. 15 shows a scene description that includes one AU, that describes the construction of a scene composed of four objects, for example, a sphere, a cube, a cone, and a cylinder, and that is written in compliance with the MPEG-4 BIFS. FIG. 16 shows an example of the scene displayed by decoding the scene description shown in FIG. 15. Referring to FIG. 16, the four objects of a sphere 41, a cube 42, a cone 44, and a cylinder 43 are displayed. The data representing the scene whose construction is described in one AU shown in FIG. 15 must be entirely decoded at a designated decoding time instant and reflected on display at a designated display time instant. The decoding time instant (time instant at which the AU should be decoded and validated) is termed a decoding time stamp (DTS) in the MPEG-4.

During the fifth scene description processing, a bit rate for data to be transmitted may have to be lowered due to the state of a transmission line or a request issued from the receiving terminal 20. Otherwise, local concentration of a processing unit the receiving terminal 20 must incur may have to be reduced. In this case, the scene description processing unit 2 in the server 10 divides a scene description into a plurality of AUs, and allocates different DTSs to the AUs. Consequently, a bit rate for part of a scene description is converted into a bit rate that conforms to the state of the transmission line or the request issued from the receiving terminal 20. A throughput required for decoding part of the scene description at each DTS is converted into a throughput that conforms to the request issued from the receiving terminal 20.

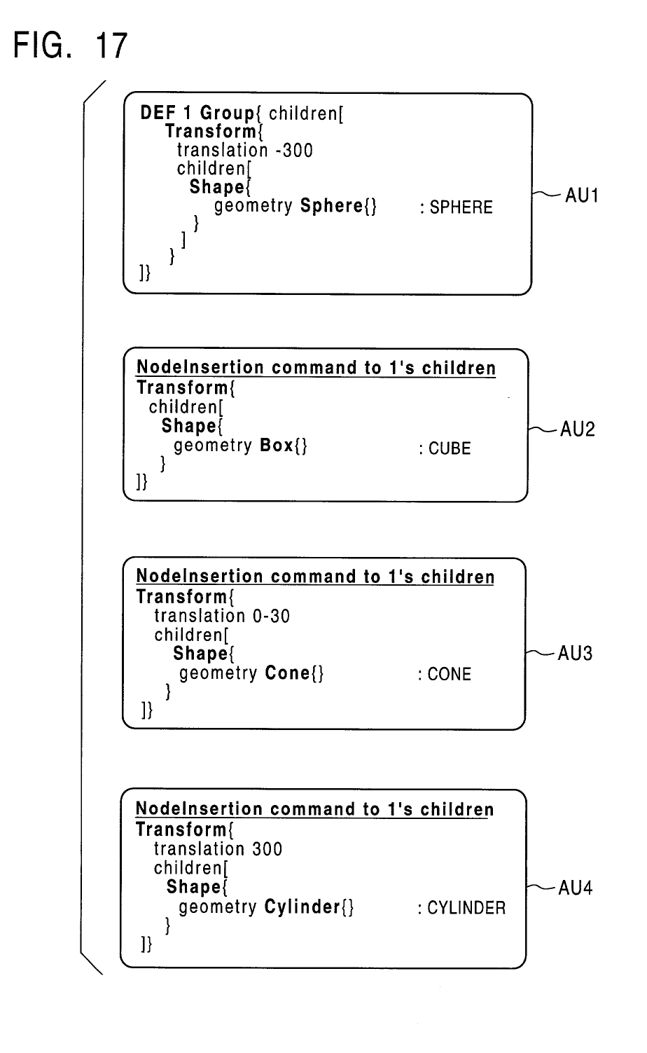

Specifically, the scene description processing unit 2 divides, for example, the scene description shown in FIG. 15 into four AUs AU1 to AU4 as shown in FIG. 17. The first AU AU1 describes that an identification (hereinafter ID) number of 1 is assigned to a node “Group” that specifies grouping. The first AU AU1 is therefore referenced by subsequent AUs. According to the MPEG-4 BIFS, a part scene description can be added to the grouping node that can be referenced. The second AU AU2 to fourth AU AU4 describe a command that instructs addition of a part scene description to a field “children” subordinate to the node “Group” to which the ID number of 1 is assigned in the first AU AU1.

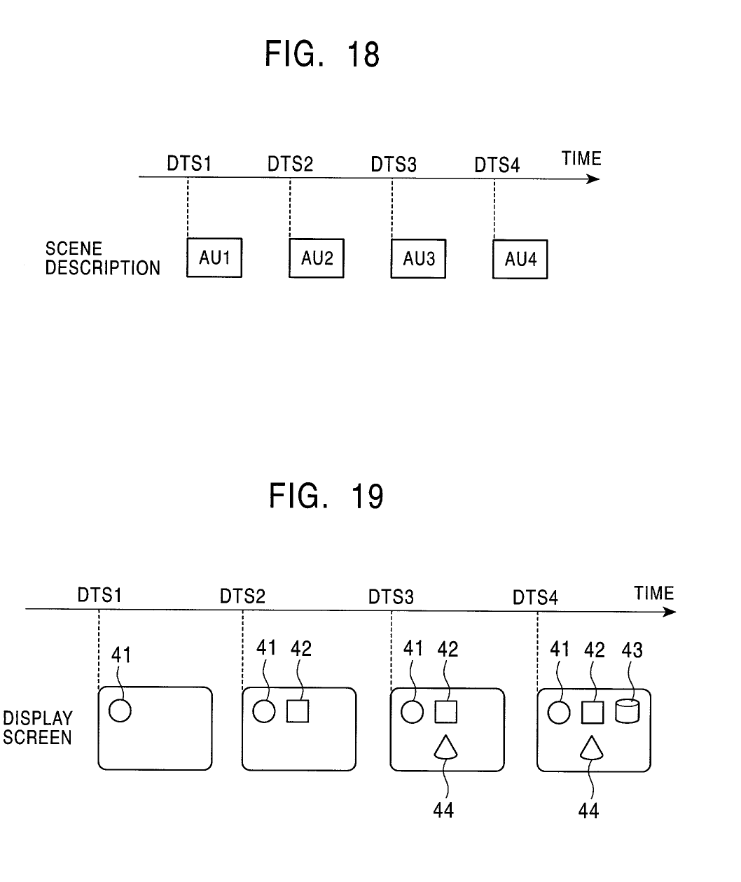

The scene description processing unit 2 designates, as shown in FIG. 18, different DTSs for the first AU AU1 to the fourth AU AU4. Specifically, a first DTS DTS1 is designated for the first AU AU1, a second DTS DTS2 is designated for the second AU AU2, a third DTS DTS3 is designated for the third AU AU3, and a fourth DTS DTS4 is designated for the fourth AU AU4. Consequently, a bit rate at which part of a scene description is transmitted from the server 10 to the receiving terminal 20 is lowered. Moreover, a load the receiving terminal 20 must incur for decoding part data at each DTS is reduced.

A scene to be displayed by decoding the four AUs, into which the scene description is divided as shown in FIG. 17, at the DTSs DTS1 to DTS4 has, as shown in FIG. 19, an object added thereto at each DTS. At the last DTS DTS4, the same scene as that shown in FIG. 16 is completed. Specifically, the sphere 41 is displayed at the first DTS DTS1, the cube 42 is added at the second DTS DTS2, the cone 44 is added at the third DTS DTS3, and the cylinder 43 is added at the fourth DTS DTS4. Eventually, the four objects are displayed.

The conversion of the scene description shown in FIG. 15 into the scene description shown in FIG. 17 which is performed during the fifth scene description processing is realized by any of actions performed by the scene description processing unit 2 as described below. Namely, a scene description that meets a criterion dependent on the state of a transmission line or a request issued from the receiving terminal 20 is selected from among a plurality of scene descriptions stored in advance in the memory 4, and then transmitted. Otherwise, a scene description is read from the memory 4 and converted into a scene description that is divided into portions (AUs AU1 to AU4) until each portion meets the criterion. Otherwise, the scene description that is divided into portions (AUs AU1 to AU4) until each portion meets the criterion is encoded in units of the portion and then transferred. The criterion employed in the fifth scene description processing may be the amount of data of one AU, the number of nodes contained in one AU, the number of objects described in one AU, the number of polygons described in one AU, or any other criterion expressing a limit relevant to one AU of a scene description.

As described so far, according to the fifth scene description processing, a scene description is divided into a plurality of AUs, and a time interval between DTSs allocated to AUs is adjusted. Thus, an average bit rate for a scene description is controlled. Incidentally, the average bit rate is calculated by dividing the sum of amounts of data of AUs to which DTSs within a certain period of time are allocated, by the period of time. The scene description processing unit 2 adjusts the time interval between DTSs so as to realize an average bit rate that conforms to the state of a transmission line or a request issued from the receiving terminal 20. In the aforesaid example, a scene description is divided into AUs. On the contrary, a plurality of AUs may be integrated into one unit.

In the above description, a case where the first scene description processing to the fifth scene description processing are performed independently of one another. Some of the scene description processing may be combined in order to perform a plurality of kinds of scene description processing concurrently. In this case, the aforesaid operations and advantages of the combined kinds of scene description processing are implemented simultaneously.

Moreover, according to the present embodiment, a scene description written in compliance with the MPEG-4 BIFS is taken for instance. The present invention is not limited to the MPEG-4 BIFS but can be applied to any scene description form. For example, a scene description form enabling description of a portion of a scene description that must be modified may be adopted. In this case, the present invention can be applied to transmission of the modified portion alone.

Furthermore, the present embodiment may be implemented in hardware or software.

According to the present invention, a scene description that conforms to the state of a transmission line and/or a request issued from a receiving side is produced. Thus, a scene description that conforms to the state of the transmission line or the processing ability of the receiving side can be transmitted to the receiving side. Consequently, occurrence of a drawback such as unexpected missing of part of a scene that is unintended to a transmitting side can be avoided. The unexpected missing results from a loss occurring on the transmission line or the insufficient processing ability of the receiving side. Even when a transmission rate at which a signal is transmitted to the receiving side is changed, the receiving side can decode data according to a scene construction that conforms to the transmission rate. Furthermore, a change in information needed to decode data can be explicitly reported to the receiving side. The receiving side is therefore relieved of the necessity of sampling the information necessary for decoding from the data represented by the signal.

What is claimed is:

1. A data transmission system having a transmitting apparatus that transmits a scene description which describes the structures of one or more signals to be used to construct a scene, and a receiving apparatus that constructs the scene according to the scene description, wherein:
said transmitting apparatus has a scene description processing means that transfers a scene description which conforms to the state of a transmission line and/or a request issued from said receiving apparatus.

2. A data transmission system according to claim 1, further comprising a memory means in which a plurality of predefined scene descriptions is stored, wherein:
said scene description processing means selects a scene description from among the plurality of scene descriptions stored in said memory means, and transfers the selected scene description.

3. A data transmission system according to claim 1, further comprising a memory means in which a plurality of predefined scene descriptions is stored, wherein:
said scene description processing means converts a predefined scene description read from said memory means into another scene description, and transfers the resultant scene description.

4. A data transmission system according to claim 1, wherein said scene description processing means encodes a scene description and transfers the resultant scene description.

5. A data transmission system according to claim 1, wherein:
said transmitting apparatus includes a signal processing means that transfers one or more signals, which conform to the state of a transmission line and/or a request issued from said receiving apparatus, as one or more signals to be used to construct a scene; and
said scene description processing means transfers a scene description that conforms to a transmission rate for a signal transferred from said signal processing means and/or quality.

6. A data transmission system according to claim 1, wherein:
said transmitting apparatus includes a signal processing means that transfers one or more signals, which conform to the state of a transmission line and/or a request issued from said receiving apparatus, as one or more signals to be used to construct a scene; and
said scene description processing means transfers a scene description that includes information necessary for said receiving apparatus to decode the signals transferred from said signal processing means.

7. A data transmission system according to claim 1, wherein:
said transmitting apparatus includes a signal processing means that transfers one or more signals, which conform to the state of a transmission line and/or a request issued from said receiving apparatus, as one or more signals to be used to construct a scene; and
said scene description processing means transfers a scene description that specifies whether the signals to be used to construct a scene are used or not.

8. A data transmission system according to claim 1, wherein said scene description processing means transfers a scene description whose complexity conforms to the state of a transmission line and/or a request issued from said receiving apparatus.

9. A data transmission system according to claim 8, wherein said scene description processing means transfers a scene description, with which a first part scene within a scene is replaced with a second part scene whose complexity is different from the complexity of the first part scene, in conformity with the state of a transmission line and/or a request issued from said receiving apparatus.

10. A data transmission system according to claim 8, wherein said scene description processing means transfers a scene description, with which a part scene within a scene is removed or a new part scene is added to the scene, in conformity with the state of a transmission line and/or a request issued from said receiving apparatus.

11. A data transmission system according to claim 8, wherein said scene description processing means modifies a quantization step, at which a scene description is encoded, in conformity with the state of a transmission line and/or a request issued from said receiving apparatus.

12. A data transmission system according to claim 1, wherein said scene description processing means divides a scene description into a plurality of decoding units in conformity with the state of a transmission line and/or a request issued from said receiving apparatus, and then transfers the resultant scene description.

13. A data transmission system according to claim 12, wherein said scene description processing means adjusts a time interval between time instants at which said receiving apparatus decodes each of the plurality of decoding units into which a scene description is divided.

14. A data transmitting method for transmitting a scene description that describes the structures of one or more signals to be used to construct a scene, and constructing the scene according to the scene description, wherein:
a scene description that conforms to the state of a transmission line and/or a request issued from a receiving side is transmitted.

15. A data transmitting method according to claim 14, wherein:
a plurality of predefined scene descriptions is stored; and
a scene description is selected from among the plurality of stored scene descriptions, and then transmitted.

16. A data transmission system according to claim 14, wherein:
predefined scene descriptions are stored; and
any of the predefined scene descriptions that are stored is read, converted into another scene description, and then transmitted.

17. A data transmission system according to claim 14, wherein a scene description is encoded and transmitted.

18. A data transmission system according to claim 14, wherein:
one or more signals that conform to the state of a transmission line and/or a request issued from a receiving side are transmitted as one or more signals to be used to construct a scene; and
a scene description that conforms to a transmission rate at which the signals are transmitted in compliance with the state of a transmission line and/or a request issued from a receiving side, and/or quality is transmitted.

19. A data transmitting method according to claim 14, wherein:
one or more signals that conform to the state of a transmission line and/or a request issued from a receiving side are transmitted as one or more signals to be used to construct a scene; and
a scene description that includes information necessary for a receiving side to restore the signals transmitted in conformity with the state of the transmission line and/or the request issued from the receiving side is transmitted.

20. A data transmission system according to claim 14, wherein:
one or more signals that conform to the state of a transmission line and/or a request issued from a receiving side are transmitted as one or more signals to be used to construct a scene; and
a scene description that specifies whether the signals to be used to construct a scene are used or not is transmitted.

21. A data transmission system according to claim 14, wherein a scene description whose complexity conforms to the state of a transmission line and/or a request issued from a receiving side is transmitted.

22. A data transmission system according to claim 21, wherein a scene description with which a first part scene within a scene is replaced with a second part scene whose complexity is different from the complexity of the first part scene is transmitted in conformity with the state of a transmission line and/or a request issued from a receiving side.

23. A data transmitting method according to claim 21, wherein, a scene description with which a part scene within a scene is removed or a new part scene is added to the scene is transmitted in conformity with the state of a transmission line and/or a request issued from a receiving side.

24. A data transmitting method according to claim 21, wherein a quantization step at which a scene description is encoded is modified in conformity with the state of a transmission line and/or a request issued from a receiving side.

25. A data transmitting method according to claim 14, wherein a scene description is divided into a plurality of decoding units in conformity with the state of a transmission line and/or a request issued from a receiving side, and then transmitted.

26. A data transmitting method according to claim 25, wherein a time interval between time instants at which a receiving side decodes each of the plurality of decoding units into which a scene description is divided is adjusted.

27. A data transmitting apparatus for transmitting a scene description that describes the structures of one or more signals to be used to construct a scene, comprising:
a scene description processing means for transferring a scene description that conforms to the state of a transmission line and/or a request issued from a receiving side.

28. A data transmitting apparatus according to claim 27, further comprising:
a memory means in which a plurality of predefined scene descriptions is stored, wherein:
said scene description processing means selects a scene description from among the plurality of scene descriptions stored in said memory means, and transmits the selected scene description.

29. A data transmitting apparatus according to claim 27, further comprising:
a memory means in which predefined scene descriptions are stored, wherein:
said scene description processing means converts a predefined scene description read from said memory means into another scene description, and transfers the resultant scene description.

30. A data transmitting apparatus according to claim 27, wherein said scene description processing means encodes a scene description and transmits the resultant scene description.

31. A data transmitting apparatus according to claim 27, further comprising a signal processing means that transfers one or more signals, which conform to the state of a transmission line and/or a request issued from a receiving side, as one or more signals to be used to construct a scene, wherein:
said scene description processing means transfers a scene description that conforms to a transmission rate for the signals transferred from said signal processing means and/or quality.

32. A data transmitting apparatus according to claim 27, further comprising a signal processing means that transfers one or more signals, which conform to the state of a transmission line and/or a request issued from a receiving side, as one or more signals to be used to construct a scene, wherein:
said scene description processing means transfers a scene description that includes information necessary for a receiving side to decode the signals transferred from said signal processing means.

33. A data transmitting apparatus according to claim 27, further comprising a signal processing means that transfers one or more signals, which conform to the state of a transmission line and/or a request issued from a receiving side, as one or more signals to be used to construct a scene, wherein:
said scene description processing means transfers a scene description that specifies whether the signals to be used to construct a scene are used or not.

34. A data transmitting apparatus according to claim 27, wherein said scene description processing means transfers a scene description whose complexity conforms to the state of a transmission line and/or a request issued from a receiving side.

35. A data transmitting apparatus according to claim 34, wherein said scene description processing means transfers a scene description, with which a first part scene within a scene is replaced with a second part scene whose complexity is different from the complexity of the first part scene, in conformity with the state of a transmission line and/or a request issued from a receiving side.

36. A data transmitting apparatus according to claim 34, wherein said scene description processing means transfers a scene description, with which a part scene within a scene is removed or a new part scene is added to the scene, in conformity with the state of a transmission line and/or a request issued from a receiving side.

37. A data transmitting apparatus according to claim 34, wherein said scene description processing means modifies a quantization step, at which a scene description is encoded, in conformity with the state of a transmission line and/or a request issued from a receiving side.

38. A data transmitting apparatus according to claim 27, wherein said scene description processing means divides a scene description into a plurality of decoding units in conformity with the state of a transmission line and/or a request issued from a receiving side.

39. A data transmitting apparatus according to claim 38, wherein said scene description processing means adjusts a time interval between time instants at which a receiving side decodes each of the plurality of decoding units into which a scene description is divided.

40. A data transmitting method for transmitting a scene description that describes the structures of one or more signals to be used to construct a scene, wherein:
a scene description that conforms to the state of a transmission line and/or a request issued from a receiving side is transmitted.

41. A data transmitting method according to claim 40, wherein a plurality of predefined scene descriptions is stored, and a scene description selected from among the plurality of scene descriptions that are stored is transmitted.

42. A data transmitting method according to claim 40, wherein predefined scene descriptions are stored, and a predefined scene description that is stored is read, converted into another scene description, and then transmitted.

43. A data transmitting method according to claim 40, wherein a scene description is encoded and transmitted.

44. A data transmitting method according to claim 40, wherein: one or more signals that conform to the state of a transmission line and/or a request issued from a receiving side are transmitted as one or more signals to be used to construct a scene; and
a scene description that conforms to a transmission rate at which the signals are transmitted in conformity with the state of a transmission line and/or a request issued from a receiving side, and/or quality is transmitted.

45. A data transmitting method according to claim 40, wherein: one or more signals that conform to the state of a transmission line and/or a request issued from a receiving side are transmitted as one or more signals to be used to construct a scene; and
a scene description that includes information necessary for a receiving side to decode the signals transmitted in conformity with the state of a transmission line and/or a request issued from the receiving side.

46. A data transmitting method according to claim 40, wherein: one or more signals that conform to the state of a transmission line and/or a request issued from a receiving side are transmitted as one or more signals to be used to construct a scene; and
a scene description that specifies whether the signals to be used to construct a scene are used or not is transmitted.

47. A data transmitting method according to claim 40, wherein a scene description whose complexity conforms to the state of a transmission line and/or a request issued from a receiving side is transmitted.

48. A data transmitting method according to claim 47, wherein a scene description, with which a first part scene within a scene is replaced with a second part scene whose complexity is different from the complexity of the first part scene, is transmitted in conformity with the state of a transmission line and/or a request issued from a receiving side.

49. A data transmitting method according to claim 47, wherein a scene description, with which a part scene within a scene is removed or a new part scene is added to the scene, is transferred in conformity with the state of a transmission line and/or a request issued from a receiving side.

50. A data transmitting method according to claim 47, wherein a quantization step at which a scene description is encoded is modified in conformity with the state of a transmission line and/or a request issued from a receiving side.

51. A data transmitting method according to claim 40, wherein a scene description is divided into a plurality of decoding units in conformity with the state of a transmission line and/or a request issued from a receiving side.

52. A data transmitting method according to claim 51, wherein a time interval between time instants at which a receiving side decodes each of the plurality of decoding units into which a scene description is divided is adjusted.

53. A scene description processing unit for processing a scene description that describes the structures of one or more signals to be used to construct a scene, wherein:
when a scene description must be transmitted over a transmission line, a scene description that conforms to the state of the transmission line and/or a request issued from a receiving side is transferred.

54. A scene description processing unit according to claim 53, wherein a scene description is selected from among a plurality of predefined scene descriptions, and then transferred.

55. A scene description processing unit according to claim 53, wherein a predefined scene description is converted into another scene description, and then transferred.

57. A scene description processing unit according to claim 53, wherein a scene description that conforms to a transmission rate, at which the signals are transmitted in conformity with the state of a transmission line and/or a request issued from a receiving side as one or more signals to be used to construct a scene, and/or quality is transferred.

58. A scene description processing unit according to claim 53, wherein a scene description that includes information necessary for a receiving side to decode the signals, which are transferred in conformity with the state of a transmission line and/or a request issued from the receiving side as one or more signals to be used to construct a scene, is transferred.

59. A scene description processing unit according to claim 53, wherein a scene description that specifies whether the signals that are transferred in conformity with the state of a transmission line and/or a request issued from a receiving side as one or more signals to be used to construct a scene are used or not is transferred.

60. A scene description processing unit according to claim 53, wherein a scene description whose complexity conforms to the state of a transmission line and/or a request issued from a receiving side is transferred.

61. A scene description processing unit according to claim 60, wherein a scene description with which a first part scene within a scene is replaced with a second part scene whose complexity is different from the complexity of the first part scene is transferred in conformity with the state of a transmission line and/or a request issued from a receiving side.

62. A scene description processing unit according to claim 60, wherein a scene description with which a part scene within a scene is removed or a new part scene is added to the scene is transferred in conformity with the state of a transmission line and/or a request issued from a receiving side.

63. A scene description processing unit according to claim 60, wherein a quantization step at which a scene description is encoded is modified in conformity with the state of a transmission line and/or a request issued from a receiving side.

64. A scene description processing unit according to claim 53, wherein a scene description is divided into a plurality of decoding units in conformity with the state of a transmission line and/or a request issued from a receiving side, and then transferred.

65. A scene description processing unit according to claim 64, wherein a time interval between time instants at which a receiving side decodes each of the plurality of decoding units into which a scene description is divided is adjusted.

66. A scene description processing method for processing a scene description that describes the structures of one or more signals to be used to construct a scene, wherein:
when a scene description must be transmitted over a transmission line, a scene description that conforms to the state of the transmission line and/or a request issued from a receiving side is transferred.

67. A scene description processing method according to claim 66, wherein a scene description is selected from among a plurality of predefined scene descriptions, and then transferred.

68. A scene description processing method according to claim 66, wherein a predefined scene description is converted into another scene description, and then transferred.

69. A scene description processing method according to claim 66, wherein a scene description is encoded and then transferred.

70. A scene description processing method according to claim 66, wherein a scene description that conforms to a transmission rate, at which the signals are transmitted in conformity with the state of a transmission line and/or a request issued from a receiving signal as one or more signals to be used to construct a scene, and/or quality is transferred.

71. A scene description processing method according to claim 66, wherein a scene description that includes information necessary for a receiving signal to decode the signals that are transferred in conformity with the state of a transmission line and/or a request issued from the receiving signal as one or more signals to be used to construct a scene is transferred.

72. A scene description processing method according to claim 66, wherein a scene description that specifies whether the signals which are transferred in conformity with the state of a transmission line and/or a request issued from a receiving signal as one or more signals to be used to construct a scene are used or not is transferred.

73. A scene description processing method according to claim 66, wherein a scene description whose complexity conforms to the state of a transmission line and/or a request issued from a receiving side is transferred.

74. A scene description processing method according to claim 73, wherein a scene description with which a first part scene within a scene is replaced with a second part scene whose complexity is different from the complexity of the first part scene is transferred in conformity with the state of a transmission line and/or a request issued from a receiving side.

75. A scene description processing method according to claim 73, wherein a scene description with which a part scene within a scene is removed or a new part scene is added to the scene is transferred in conformity with the state of a transmission line and/or a request issued from a receiving side.

76. A scene description processing method according to claim 73, wherein a quantization step at which a scene description is encoded is modified in conformity with the state of a transmission line and/or a request issued from a receiving side.

77. A scene description processing method according to claim 66, wherein a scene description is divided into a plurality of decoding units in conformity with the state of a transmission line and/or a request issued from a receiving side.

78. A scene description processing method according to claim 77, wherein a time interval between time instants at which a receiving side decodes each of the plurality of decoding units into which a scene description is divided is adjusted.
